(19) United States
(12) Patent Application Publication
(10) Pub. No.: US 2025/0328358 A1
(43) Pub. Date: Oct. 23, 2025

(54) CLOUD APPLICATION SERVICE MESH CONTROLLED GAMIFICATION

(71) Applicant: INTERNATIONAL BUSINESS MACHINES CORPORATION, ARMONK, NY (US)

(72) Inventors: Albee Jhoney, Bangalore (IN); Rishi Patel, Rajkot (IN); Suraj S, Bangalore (IN); Mahesh Kumawat, Bangalore (IN); Janardhana Anipireddy, Nellore (IN)

(21) Appl. No.: 18/640,247

(22) Filed: Apr. 19, 2024

(51) Int. Cl. G06F 9/445; G06F 8/75; H04L 9/40

(52) U.S. Cl. CPC G06F 9/44526; G06F 8/75; H04L 63/306

(57) ABSTRACT

According to one embodiment, a method, computer system, and computer program product for gamification of a cloud application is provided. The present invention may include intercepting communications between an end device and the application using a service mesh; analyzing frontend code of the application and external and internal network traffic of the application to produce a plurality of analyzed data; identifying an application-agnostic gamification strategy based on one or more user interface (UI) elements in the application; identifying an application-aware gamification strategy based on the plurality of analyzed data; and dynamically injecting gamification elements from the identified gamification strategies into the frontend code of the application.

### BACKGROUND

The present invention relates, generally, to the field of computing, and more particularly to application software.

Application software is a subset of computer software designed to perform a specific task other than one relating to the operation of the computer itself. Application software may include word processors, web browsers, accounting software, education software, as well as healthcare software. Application software is often designed to be used on mobile devices for recreation, etc. Depending on the activity for which the application was designed, the specified tasks may include manipulating text, graphics, audio, as well as a combination of the tasks.

### SUMMARY

Embodiments of a method, a computer system, and a computer program product for gamification of an application are described. According to at least one embodiment, a method, computer system, and computer program product for gamification of an application may include intercepting communications between an end device and the application using a service mesh; analyzing frontend code of the application and external and internal network traffic of the application to produce a plurality of analyzed data; identifying an application-agnostic gamification strategy based on one or more user interface (UI) elements in the application; identifying an application-aware gamification strategy based on the plurality of analyzed data; and dynamically injecting gamification elements from the identified gamification strategies into the frontend code of the application.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating a cloud application service mesh gamification implementation process according to at least one embodiment.

FIG. 3 is a system diagram illustrating an exemplary program environment of an implementation of a cloud application service mesh gamification implementation process according to at least one embodiment.

FIG. 4 illustrates well-known user interface components depicted within the gamification knowledgebase module for application-agnostic gamification according to at least one embodiment.

FIG. 5 illustrates code patterns implemented using well-known user interface frameworks depicted within the gamification knowledgebase module for application-aware gamification according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to gamification, in particular, using aspect-oriented programming techniques to inject gamification aspects into an application's existing frontend code. The present embodiment has the capacity to improve the implementation of gamification aspects in applications for application owners, administrators, and/or developers, as well as to improve the overall user experience during the use of the applications. Gamification is modifying a software program to include game-like elements, both in terms of the visual aspects of the graphical user interface and in terms of how the user fundamentally interacts with the application. The integration of game-like elements can make the process of interacting with the application more like a game and therefore, more engaging to the user. A gamification strategy includes a software package that executes to insert an array of UI changes, such as points, badges, leaderboards, challenges, rewards, and solutions, into an application that is tailored to a particular purpose or target. A gamification strategy may comprise application code, GUI elements, subroutines, etc., that implement the strategy upon being inserted into an application's code.

The present embodiment can dynamically inject gamification elements from identified application-agnostic and application-aware gamification strategies into a cloud application's frontend code based on the application being used, usage patterns of the application, and one or more user experience goals. An application-aware gamification strategy may be a strategy that can be used with the specific application, considering, for example, the domain, application state, etc., of the application. An application-agnostic gamification strategy may be a strategy that can be used with any application, for example, extending a password field in the application's frontend code.

Currently, gamification aspects can be implemented into an application by manually modifying the backend of the application code to include those gamification aspects or by building a gamified application from the ground up. However, there are numerous disadvantages to the current methods that can lead to problems and frustration among application owners, application developers, and users. For application owners, dynamically gamifying an application using the current methods is not possible as updating the gamification elements in the application requires modifying the application's source code. For application developers looking to modify an application's source code to add game-like aspects, assistance remains limited within the integrated development environments (IDEs). For users, frustration arising from service disruptions during modification of the source code to gamify the application or coding errors can likely lead to the users pausing their use of the application. Thus, an implementation of gamification in which gamification aspects are dynamically identified and injected into an application without modifying the application source code is needed.

Thus, embodiments of the present invention may provide advantages including, but not limited to, dynamically gamifying a cloud application without modifying the application's backend code. The present invention can perform dynamic gamification injection by using service meshes to enable real-time gamification adaptation based on the analysis of application features, user-application interactions, and application performance. Thereby, providing a more tailored and responsive gamification experience based on up-to-date analysis can enhance user engagement and the user experience. Additionally, the ability to inject gamification elements dynamically and seamlessly into the existing frontend code of an application can enable a wider implementation/adoption of gamification by existing cloud applications. Furthermore, the ability to inject gamification elements dynamically and seamlessly into the existing frontend code of an application ensures a non-intrusive and scalable way to inject gamification elements, thus minimizing any disruptions to the existing application. Also, dynamic gamification injection enables an application administrator to roll out gamification strategies in a controlled manner to particular users of the application and monitor the application features in real-time. The present invention does not require that all advantages need to be incorporated into every embodiment of the invention.

In at least one embodiment of the invention, the program may intercept communications between a job applicant's EUD and employment software while the applicant is filing out their credentials and qualifications on their EUD. In this scenario, the gamification controller module may integrate with the user interface code of the employment software to inject a gamification strategy including a time-based rewards system from the gamification knowledgebase module. The program may measure the time taken by the applicant to fill out their credentials and qualifications. Responsive to the applicant efficiently completing their credentials and qualifications within a predefined time, the program may reward the applicant with rewards, as well as with a badge, such as an “Efficiency Achiever” badge. This gamification strategy aims to encourage applicants to enhance their efficiency in navigating and completing their job applications. Additionally, the rewards and badges can serve as positive reinforcement for applicants to engage in completing their job applications more effectively.

Furthermore, in at least one embodiment of the invention within the same implementation of the program as the previous embodiment, the program may monitor the applicant's adherence to filing in mandatory fields. Responsive to the applicant successfully filling in all of the mandatory fields of the job application during their initial attempt, the program may reward the applicant by increasing their reward score. However, responsive to the applicant unsuccessfully completing all the mandatory fields of the job application during their initial attempt, the program may reduce the applicant's reward score. This gamification strategy encourages applicants to provide accurate and complete information during their first attempt at completing their job applications, and in doing so, can foster a sense of achievement and responsibility. Specifically, the reward points serve as positive reinforcement for applicants to engage in completing their job applications more effectively.

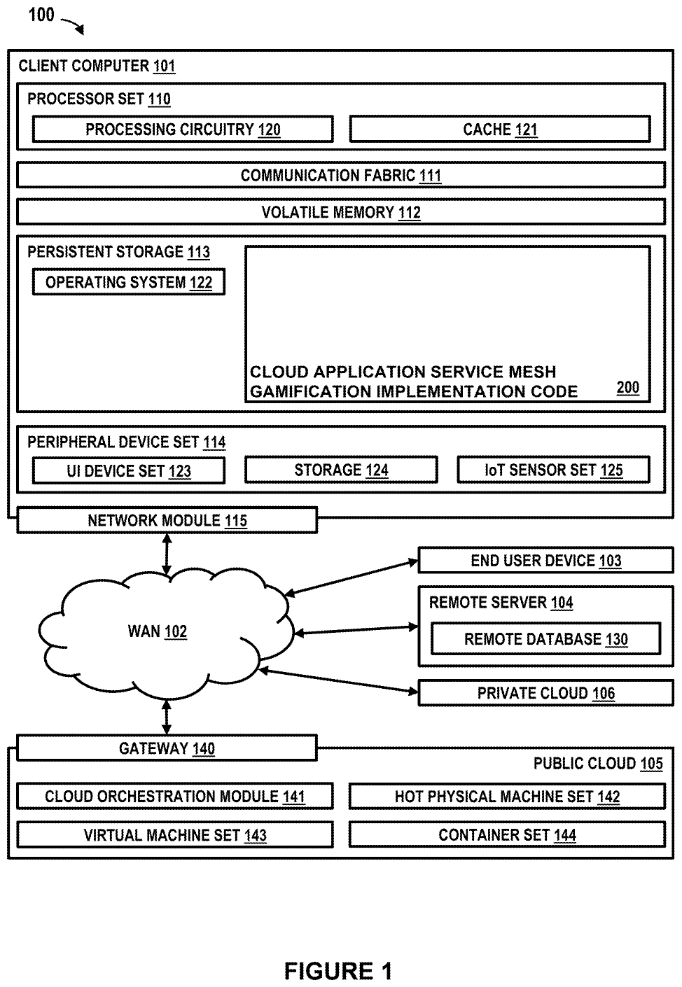

The embodiments mentioned in this paragraph are further illustrated and described below in the discussions of FIGS. 1, 2, and 3. According to at least one embodiment, the program uses a service mesh to intercept communications between an end device and the application. The program analyzes the frontend code of the application and external and internal network traffic of the application to produce a plurality of analyzed data. Also, the program identifies an application-agnostic gamification strategy based on the UI elements in the application. Moreover, the program identifies an application-aware gamification strategy based on the plurality of analyzed data. Furthermore, the program dynamically injects the gamification elements from the identified gamification strategies into the frontend code of the application.

According to at least one other embodiment, the program initializes a gamification knowledgebase as a rule-set collection. According to at least one other embodiment, the program verifies an impact of the injected gamification elements on the application. According to at least one other embodiment, the program modifies one or more of the identified gamification strategies based on collected feedback. According to at least one other embodiment, the program dynamically injects one or more user-engagement features into the frontend code in addition to the gamification elements from the identified gamification strategies. According to at least one embodiment, the program performs the dynamic injection of the gamification elements from the identified gamification strategies into the frontend code pursuant to one or more application user experience goals and one or more game control policies. According to at least one embodiment, the dynamic injection of the gamification elements from the identified gamification strategies into the frontend code further comprises injecting game hooks using injection points and rewriting a response data file of the application.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to intercept communications between an end device and the application using a service mesh, analyze the frontend code of the application and external and internal network traffic of the application to produce a plurality of analyzed data, identify an application-agnostic gamification strategy based on one or more user interface (UI) elements in the application, identify an application-aware gamification strategy based on the plurality of analyzed data, and dynamically inject gamification elements from the identified gamification strategies into the frontend code of the application.

Referring to FIG. 1, an exemplary networked computer environment 100 is depicted, according to at least one embodiment. Computing environment 100 contains an example of an environment for the execution of at least some of the computer code involved in performing the inventive methods, such as cloud application service mesh gamification implementation code 200, also referred to as “cloud application service mesh gamification implementation program” or “the program”. In addition to code block 200 computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

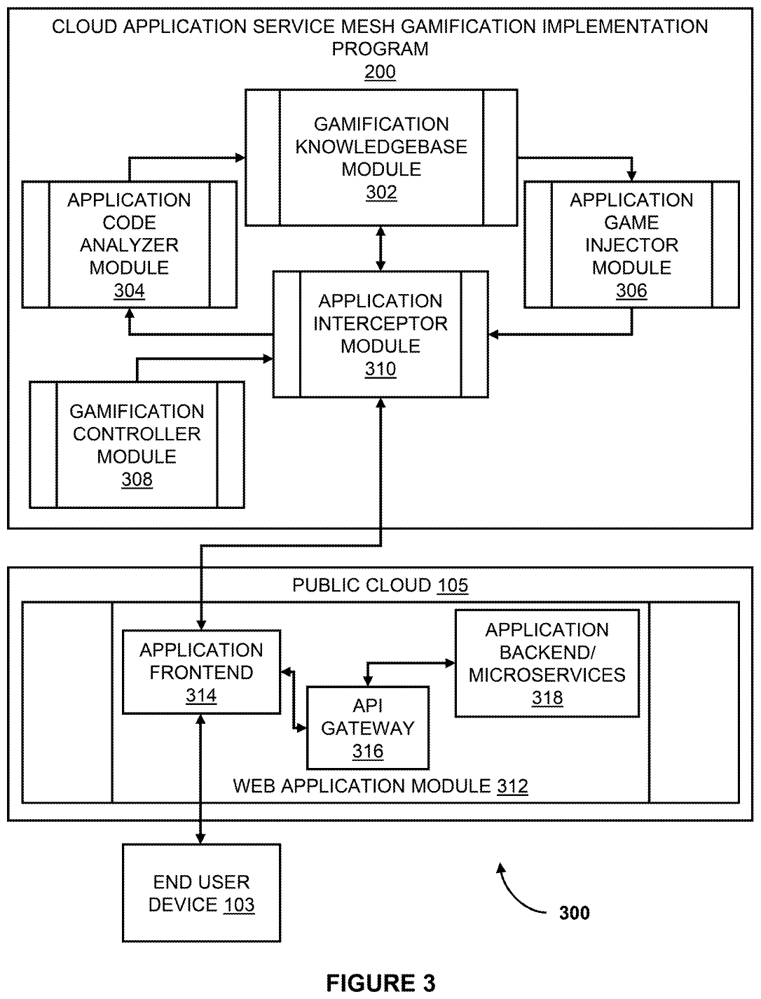

The database 130 may be a digital repository capable of data storage and data retrieval. The database 130 can be present in the remote server 104 and/or any other location in the network 102. The database 130 can comprise the gamification knowledgebase module 302 (FIG. 3). The program 200 can initialize a gamification knowledgebase module 302 from a public or organization-wide gamification-strategy repository. The gamification knowledgebase module 302 may be continuously updated with the latest information from the repository. The gamification knowledgebase module 302 can comprise a collection of gamification strategies. The gamification strategies may comprise activation rules, injection-target-locators, game hook(s), game code injectors, and game injection verifiers.

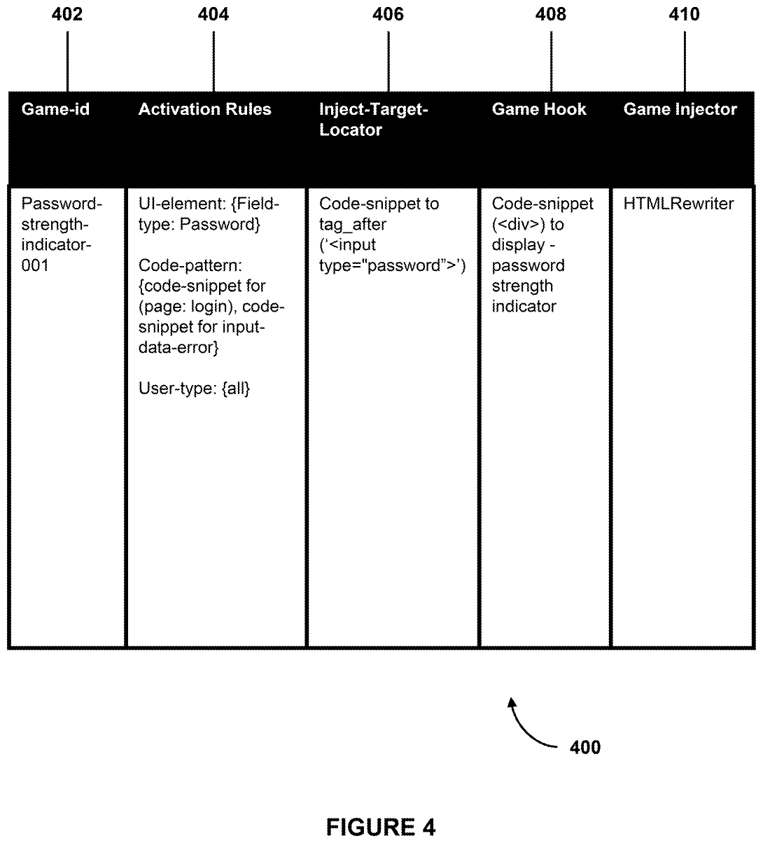

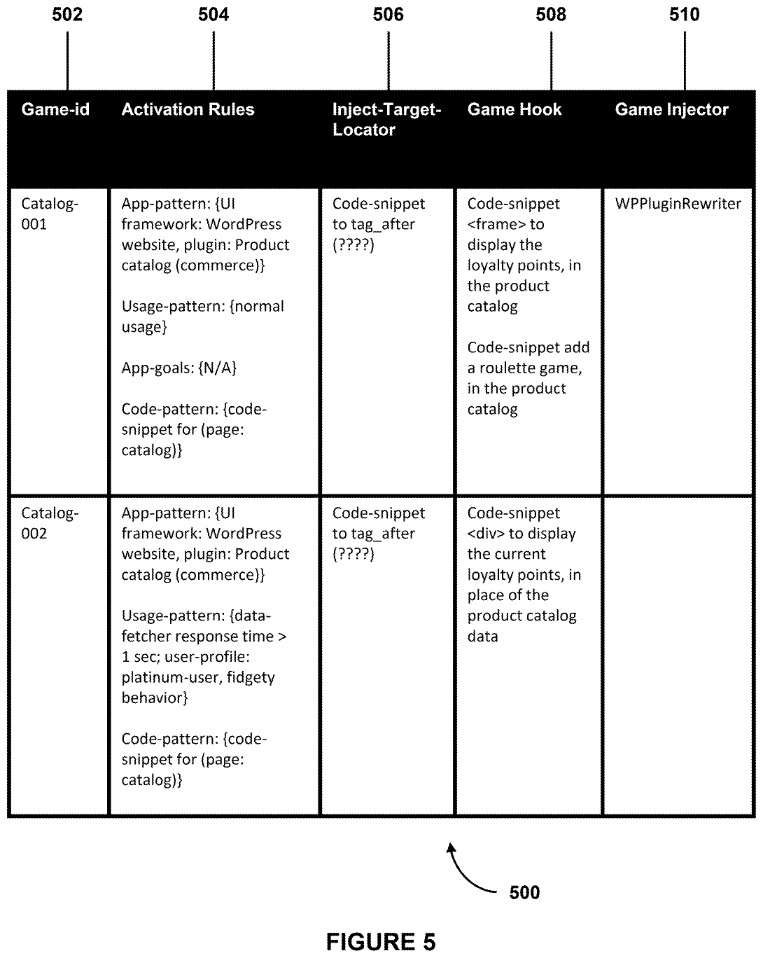

Activation rules may describe when a particular gamification strategy may be used. Injection-target-locators may be tags used to find and mark the locations in an application's frontend code 314. Game hooks may be UI elements from the gamification strategy that will be injected. Game code injectors can be code that is be used to rewrite the frontend code of an application 314. Game injection verifiers may be components that will verify the injection of a gamification strategy. The program 200 can implement the gamification knowledgebase module 302 as a rule-set collection. The gamification knowledgebase module 302 may govern and recommend appropriate gamification strategies using a rule engine that is primed with all the activation rules from the gamification strategies within the gamification knowledgebase module 302. Code patterns can be specific implementations of reusable code snippets or templates for solving a particular coding problem. Code patterns may trigger application rules. Code patterns may comprise the login page, notification(s), multi-page forms, loading content, etc. Code patterns may be implemented using well-known user interface frameworks for application-aware gamification 500 as depicted in FIG. 5. Well-known user interface frameworks for application-aware gamification 500 may comprise game IDs 502 (FIG. 5), activation rules 504 (FIG. 5), inject-target-locators 506 (FIG. 5), game hooks 508 (FIG. 5), and game injectors 510 (FIG. 5). Also, the inject-target-locators of the triggered activation rules can be used to find and mark the potential injection points in the application's frontend code 314 for each of the code patterns of the triggered activation rules. General application 312 usage characteristics may comprise error-prone usage, time-consuming flows, visual clutter, repeat pagination, multiple mouse clicks, etc. Also, code patterns may be implemented using well-known user interface frameworks for application-agnostic gamification 400 as depicted in FIG. 4. Well-known user interface frameworks for application-agnostic gamification 400 may comprise game IDs 402 (FIG. 4), activation rules 404 (FIG. 4), inject-target-locators 406 (FIG. 4), game hooks 408 (FIG. 4), and game injectors 410 (FIG. 4). Additionally, the database 130 can store additional information relating to gamification, gamification strategies, cloud applications 312 (FIG. 3), and users.

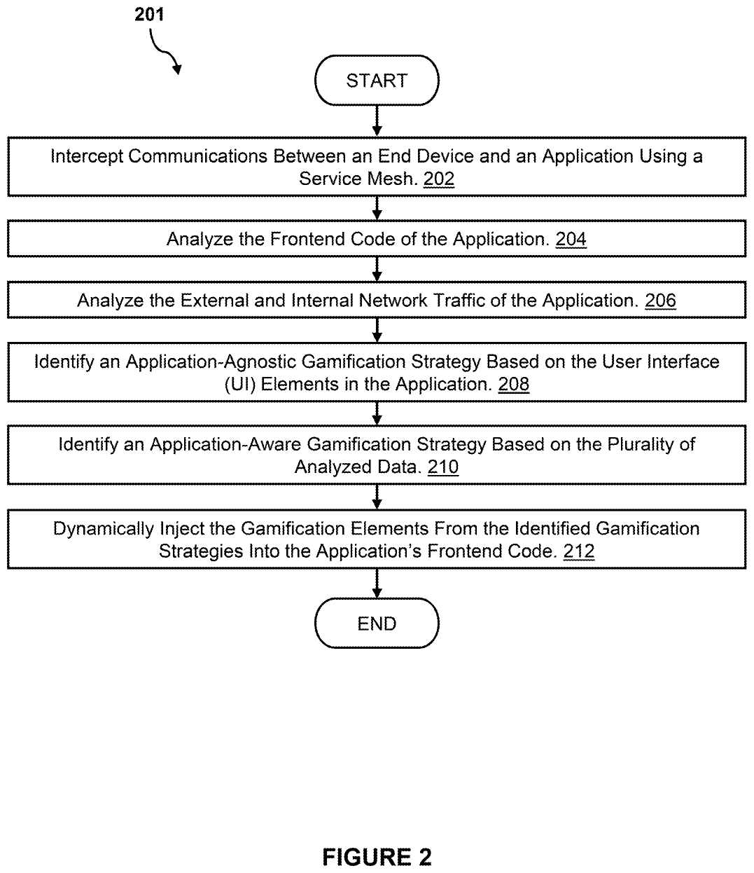

According to the present embodiment, the cloud application service mesh gamification implementation program 200 may be a program capable of analyzing the frontend code of an application and network traffic of the application to produce a plurality of analyzed data, identifying an application-agnostic gamification strategy based on the UI elements in the application, identifying an application-aware gamification strategy based on the plurality of analyzed data, and dynamically injecting gamification elements from the identified gamification strategies into the application's frontend code. The program 200 may be located on client computing device 101 or remote server 104, or end user device 103, or on any other device located within network 102. Furthermore, the program 200 may be distributed in its operation over multiple devices, such as client computing device 101 and remote server 104. The cloud application service mesh gamification implementation method is explained in further detail below with respect to FIG. 2.

Referring now to FIG. 2, an operational flowchart illustrating a cloud application service mesh gamification implementation process 201 is depicted according to at least one embodiment. At 202, the program 200 intercepts the communications (i.e., web traffic flow) between the UI of the EUD 103 and the application 312 runtime, also referred to as web application module 312, using the application interceptor module 310 (FIG. 3). The application interceptor module 310 can be implemented using an HTTP Proxy of a service mesh, such as Istio™ (Istio™ and all Istio™-based trademarks and logos are trademarks or registered trademarks of The Linux Foundation, and/or its affiliates). An application 312 can be a computer software package designed to perform a specific task for an end user or another application. An application 312 can be deployed as a collection of microservices and can be managed using the service mesh. The web application module 312 may comprise application frontend code 314 (FIG. 3), an API gateway 316 (FIG. 3), and application/backend microservices 318 (FIG. 3). The API gateway 316 may be used to expose the application backend/microservices 318 using a set of standard REST APIs. The application backend/microservices 318 may be used to implement the business logic of the application 312 and to store the business data.

The semantics of the application 312 interface can be implemented using reusable application 312 frameworks with well-known code signatures on the UI, such as reactJS™ (reactJS™ and all reactJS™-based trademarks and logos are trademarks or registered trademarks of Meta Platforms, Inc. and/or its affiliates), Carbon Components, Spring Framework™ (Spring Framework™ and all Spring Framework™-based trademarks and logos are trademarks or registered trademarks of Pivotal Software, Inc., and/or its affiliates), WordPress™ Patterns and Plugins (WordPress™ and all WordPress™-based trademarks and logos are trademarks or registered trademarks of WordPress Foundation, and/or its affiliates), Shopify™ (Shopify™ and all Shopify™-based trademarks and logos are trademarks or registered trademarks of Shopify Inc., and/or its affiliates), Drupal™ (Drupal™ and all Drupal™-based trademarks and logos are trademarks or registered trademarks of Buytaert, Dries, and/or their affiliates), Adobe™ Builder (Adobe™ and all Adobe™-based trademarks and logos are trademarks or registered trademarks of Adobe, Inc. and/or its affiliates), etc. A user may comprise a person using the application 312, such as an online shopper.

At 204, the program 200 analyzes the frontend code 314 of the application. The program 200 can analyze the application 312 to determine the type of application 312, usage patterns of the application 312, application 312 performance patterns, and application 312 user-experience goals. The program 200 can perform static analysis of the application 312 frontend code 314, comprising data and metadata, using application code analyzer module 304 (FIG. 3). The program 200 can perform static analysis of the application 312 by scanning the application's frontend code 314. Static analysis can comprise identifying the type of application 312 using simple heuristics and/or existing supervised learning techniques, identifying the multiple pages in the application's frontend code 314, classifying the pages, describing the user-interaction type, identifying the well-known UI elements, and identifying the types of user interactions. Application 312 types may comprise form-filing, document browsing, shopping, job tracking, messaging, dashboard, social networking, search, and list, etc. Well-known UI elements may be common components used in a GUI that serve a specific function or display certain content, such as fields, buttons, hyperlinks, login, filter, search, paginate, etc. The injection-target-locator entries in the gamification knowledgebase module 302 can correspond to the well-known UI elements. Types of user interactions may comprise input data fields and action fields. Input data fields may comprise passwords, choices, searches, filters, etc. Actions fields may comprise “submit”, “cancel”, etc.

At 206, using the service mesh, the program 200 analyzes the external and internal network traffic of the application 312 to determine the application's 312 performance patterns (i.e., traffic-related metrics). External traffic may comprise network interactions between the user end EUD 103 and the cloud application 312 over the WAN 102. Internal traffic may comprise network interactions between the different microservices 318 of the application 312. Application 312 performance patterns, for each application 312 UI feature/API, may comprise page refresh speed, page changes, data refresh speed, data upload speed, error response codes and messages, feature usage levels, feature response time, feature error frequency, etc. Application 312 user experience goals, for each application 312 UI feature/API, may describe the function that the feature is intended to perform for the user experience, such as attracting and retaining shoppers on a new arrivals page of a shopping cloud application 312. The program 200 can learn/define thresholds, upper and lower, for the traffic-related metrics for each application 312 UI feature/API, using the traffic-related metric data. The program 200 may send a breach event notification to an application 312 administrator using the gamification controller module 308 (FIG. 3) when a traffic-related metric threshold is broken. For each feature/API, the program 200 may learn and record the observed application 312 performance patterns based on the threshold breach events.

The program 200 can perform dynamic analysis of the internal network traffic using the application interceptor module 310. For example, the program 200 may analyze the internals of the application 312 components, such as the microservices 318, and their performance. For example, if a database microservice is slowing down due to resource constraints, the messaging microservices is overloaded, or if the integration with the external payment gateway is unreliable and/or clunky, the program 200 may recognize that the overall performance of the cloud application 312 or performance of specific features/APIs in the cloud application 312 will be affected.

The program 200 can perform dynamic analysis of the external network traffic using the application interceptor module 310. For example, the program 200 may analyze the request-response data exchanged between the UI of the EUD 103 and the application frontend code 314 (i.e., the user-application 312 interactions). The program 200 may record the time taken, error codes, error messages, etc. of the request-response events. While an application 312 is in use, the program 200 can monitor the general application 312 usage patterns of all the application users related to each application 312 UI feature/API. Usage patterns of the application 312, for each application 312 UI feature/API, may comprise page-number paginations, frequently used features, number of mouse clicks, the average duration of feature/API usage, periodic patterns of application 312 UI feature/API usage, for example, time-of-day, day-of-week, etc., error-prone areas of usage, the average time taken to accomplish a goal, etc. The program 200 may learn and record the application 312 usage patterns, for each feature/API, of each user using the monitored data. Additionally, the program 200 may collect information regarding the characteristics of the users, such as new users, repeat users, distracted users, etc.

At 208, the program 200 identifies an application-agnostic gamification strategy based on the UI elements in the application 312. The program 200 can input the application's frontend code 314, for example, in HTML, CSS, or JavaScript™ (JavaScript™ and all JavaScript™-based trademarks and logos are trademarks or registered trademarks of Oracle America, Inc. and/or its affiliates), into the gamification knowledgebase module 302 to trigger one or more activation rules within the gamification knowledgebase module 302. The gamification knowledgebase module 302 can apply the triggered activation rules to identify the application-agnostic gamification strategy based on the well-known user interface components comprised within the activation rules. Additionally, the program 200 can use the inject-target-locators of the triggered activation rules to find and mark the potential injection points in the application's frontend code 314 for each of the well-known UI elements of the triggered activation rules. The inject-target-locators can be target attributes that specify locations where a UI element may be inserted into frontend code 314. Injection points can be locations in the application's frontend code 314 where new code can be entered to modify the UI of the application 312. Specifically, the program 200 can build a trie data structure using the injection-target-locators to identify code injection points in the application's frontend code 314. A trie can be a type of k-ary search tree, a multiway tree data structure used for storing and searching keys from within a set.

The program 200 may filter the injection points of game IDs using the gamification controller module 308 and considering application 312 user experience goals and game control policies, as set by an application 312 administrator. Game control policies may define when/where a game ID can be injected, such as injecting a game ID only in a select country, for example, the United States, enabling a feature for users only of a certain age group, such as users older than eighteen years old, disabling a gamification strategy when the traffic conditions, or workload, are greater than a threshold, etc. Thus, the program 200 may filter the injection points of game IDs to include only those game IDs that can be injected for users in the United States. The program 200 may define game control policies for one or more game IDs in the gamification knowledgebase module 302. A user experience goal may define tasks for an application 312 feature, such as encouraging users to spend time on a certain page of the application 312 and minimizing the possibility of errors while using the application 312. For example, a user experience goal may include encouraging users to spend more time on the new arrivals page of a shopping application 312. Thus, the program 200 may filter the injection points of game IDs to include only those game IDs that comprise giving users time-based rewards and/or visit-based rewards for the new arrivals page of the shopping application 312. The program 200 may define application 312 user experience goals for one or more application 312 UI features/APIs in the gamification knowledgebase module 302. The program 200 can save the potential injection points of game IDs from the identified application-agnostic gamification strategy in the application frontend code 314, in preparation for injecting the application 312 with the application-agnostic gamification strategy.

In at least one embodiment, the program 200 may use the gamification controller module 308 to collect feedback on user experience (UX) improvements from users. Also, the program 200 may use the gamification controller module 308 to collect feedback on application 312 UI feature/API outcomes before and after injecting a game ID into the application 312. The program 200 may use traditional user experience research methodologies to collect UX feedback from users. Additionally, the program 200 may use an automated method to collect feedback, the method comprising: (1) clustering users based on common features or usage characteristics; (2) sampling N users, and dividing them into two or more groups for each cluster; (3) using the traffic management and traffic routing features in the service mesh to deliver the application 312 with gamification strategies to one (1) group and without gamification strategies to the other group; (4) measuring the application's 312 business outcomes for each group; and (5) recording the UX test outcomes, learning patterns in the improvements/degradation of the application 312 outcomes, and reporting successes/failures. Furthermore, the program 200 may use the gamification controller module 308 to identify and recommend opportunities for gamification of the application 312 UI features/APIs based on the received feedback and UX test outcomes. The program 200 may review all the game IDs, and the application 312 UI features/APIs to identify the gamification opportunities by: (1) continuously monitoring the application's 312 business outcomes for all the application 312 UI features/APIs to track changes and trends; (2) tracking the game IDs that were used and previously impacted the business outcomes for all application 312 UI features/APIs; (3) collecting all the application 312 UI features/APIs that do not have a game ID assigned to them; (4) collecting all the application 312 UI features/APIs whose business outcomes have deteriorated or not changed a gamification strategy, for a predefined duration, since the introduction of the last game ID; and (5) displaying the collected application 312 UI features/APIs as opportunities for gamification or changes in gamification strategies.

At 210, the program 200 dynamically identifies an application-aware gamification strategy based on the analyzed application frontend code 314 and the external and internal network traffic of the application 312. The program 200 can input the analyzed data into the gamification knowledgebase module 302 to trigger one or more activation rules within the gamification knowledgebase module 302. The gamification knowledgebase module 302 can apply the triggered activation rules to identify the application-aware gamification strategy based on the code patterns implemented using well-known user interface frameworks comprised within the activation rules. Additionally, the inject-target-locators of the triggered activation rules can be used to find and mark the potential injection points in the application's frontend code 314 for each of the code patterns of the triggered activation rules. Specifically, the program 200 can build a trie data structure using the injection-target-locators within the activation rules to identify potential code injection points in the application's frontend code 314. The program 200 can filter the application-aware gamification strategies in the same method as the program 200 filters the application-agnostic gamification strategies. The program 200 can save the injection points for the identified application-aware gamification strategy in the application frontend code 314, in preparation for injecting the application 312 with the application-aware gamification strategy.

At 212, the program 200 dynamically injects the gamification/UI elements from the identified gamification strategies into the cloud application's frontend code 314 in a selective and controlled manner. The program 200 can fetch the game hooks and game injectors for the respective recommended gamification strategies, identified in Steps 208 and 210, from the gamification knowledgebase module 302. The program 200 can use the application game injector module 306 (FIG. 3) to perform actual code injection of the gamification strategy and/or to rewrite the response data file of the application 312 with the gamification elements and game hooks from the gamification strategy based on the recommended injection points. The application game injector module 306 may comprise server-side or client-side injectors. Server-side injectors may comprise browser extensions that can add or change an HTML, CSS, or JavaScript™ file with pre-defined/simple gamification logic, for example, Zenhub™ extension for GitHub™ (JavaScript™ and all JavaScript™-based trademarks and logos are trademarks or registered trademarks of Oracle America, Inc. and/or its affiliates), (GitHub™ and all GitHub™-based trademarks and logos are trademarks or registered trademarks of GitHub, Inc. and/or its affiliates), (Zenhub™ and all Zenhub™-based trademarks and logos are trademarks or registered trademarks of Axiom Labs, Inc. and/or its affiliates). Client-side injectors may comprise using the proxy or sidecars of a service mesh to dynamically modify a response header and body. In at least one embodiment, the program 200 may use the gamification controller module 308 to continuously monitor the usage and verify the effectiveness of the injected gamification strategy(-ies).

In at least one embodiment, the program 200 may use the application game injector module 306 to verify the changes made to the response body, for consistency, security, and safeguards, via standard code-scanning tools. Furthermore, the program 200 can use the service mesh to verify the impact of the gamification on the application 312 and its behavior after the injection of the gamification elements. Specifically, the program 200 can use the traffic management and traffic routing features of the service mesh to selectively target a subset of users and inject the gamification strategy to the Beta users. The Beta users can use automated functional UI testing tools to verify the application 312 UI features/APIs and confirm that the regular application 312 usage and interactions are not disturbed due to the injected gamification elements. Additionally, the Beta users can use automated visual UI testing tools to verify whether the application's 312 visual experience continues to follow the UX/design guidelines, and that the gamification elements have not introduced too much clutter, color, undesirable layout changes, pixel alignments, etc., to the application 312. The program 200 can record the test outcomes from the Beta users and automated testing. The program 200 can learn patterns from the test outcomes and analyze them to report successes and failures, used as inputs in Steps 208 and 210 while recommending the gamification elements and injection points. Furthermore, the program 200 can use the traffic routing management features of the service mesh to roll out and expand the gamification coverage to more users of the application 312 in a controlled manner.

In at least one embodiment of the invention, the program 200 may dynamically inject user-engagement features, such as advertisements, market research, surveys, inline help, chatbots, and contextual alerts, for example, application maintenance or new feature releases. The program 200 may inject the user-engagement features using the application game injector module 306, in the same method as in Step 210.

Referring now to FIG. 3, a system diagram illustrating an exemplary program environment 300 of an implementation of a cloud application service mesh gamification implementation process 201 is depicted according to at least one embodiment. Here, the program 200 comprises a gamification knowledgebase module 302, an application code analyzer module 304, an application game injector module 306, a gamification controller module 308, and an application interceptor module 310. The exemplary program environment 300 details the passage of data between the gamification knowledgebase module 302 and the application code analyzer module 304, the gamification knowledgebase module 302 and the application game injector module 306, the gamification knowledgebase module 302 and the application interceptor module 310, the application code analyzer module 304 and the application interceptor module 310, the application game injector module 306 and the application interceptor module 310, and the application interceptor module 310 and the gamification controller module 308. Additionally, the exemplary program environment 300 details the passage of data between the application interceptor module 310 and an application frontend code 314 in a web application module 312 within the public cloud 105, and application frontend code 314 and the end user device 103.

It may be appreciated that FIGS. 2 through 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for gamification of an application, the method comprising:
intercepting communications between an end device and the application using a service mesh;
analyzing frontend code of the application and external and internal network traffic of the application to produce a plurality of analyzed data;
identifying an application-agnostic gamification strategy based on one or more user interface (UI) elements in the application;
identifying an application-aware gamification strategy based on the plurality of analyzed data; and
dynamically injecting gamification elements from the identified gamification strategies into the frontend code of the application.

2. The method of claim 1, the method further comprising:
initializing a gamification knowledgebase as a rule-set collection.

3. The method of claim 1, the method further comprising:
verifying an impact of the injected gamification elements on the application.

4. The method of claim 1, the method further comprising:
modifying one or more of the identified gamification strategies based on collected feedback.

5. The method of claim 1, the method further comprising:
dynamically injecting one or more user-engagement features into the frontend code in addition to the gamification elements from the identified gamification strategies.

6. The method of claim 1, wherein dynamically injecting the gamification elements from the identified gamification strategies into the frontend code is performed pursuant to one or more application user experience goals and one or more game control policies.

7. The method of claim 1, wherein dynamically injecting the gamification elements from the identified gamification strategies into the frontend code further comprises injecting game hooks using injection points and rewriting a response data file of the application.

8. A computer system for gamification of a cloud application, the computer system comprising:
one or more processors, one or more computer-readable memories, one or more computer-readable tangible storage mediums, and program instructions stored on at least one of the one or more tangible storage medium for execution by at least one of the one or more processors via at least one of the one or more memories, wherein the computer system is capable of performing a method comprising:
intercepting communications between an end device and the application using a service mesh;
analyzing frontend code of the application and external and internal network traffic of the application to produce a plurality of analyzed data;
identifying an application-agnostic gamification strategy based on one or more user interface (UI) elements in the application;
identifying an application-aware gamification strategy based on the plurality of analyzed data; and
dynamically injecting gamification elements from the identified gamification strategies into the frontend code of the application.

9. The computer system of claim 8, the method further comprising:
initializing a gamification knowledgebase as a rule-set collection.

10. The computer system of claim 8, the method further comprising:
verifying an impact of the injected gamification elements on the application.

11. The computer system of claim 8, the method further comprising:
modifying one or more of the identified gamification strategies based on collected feedback.

12. The computer system of claim 8, the method further comprising:
dynamically injecting one or more user-engagement features into the frontend code in addition to the gamification elements from the identified gamification strategies.

13. The computer system of claim 8, wherein dynamically injecting the gamification elements from the identified gamification strategies into the frontend code is performed pursuant to one or more application user experience goals and one or more game control policies.

14. The computer system of claim 8, wherein dynamically injecting the gamification elements from the identified gamification strategies into the frontend code further comprises injecting game hooks using injection points and rewriting a response data file of the application.

15. A computer program product for gamification of a cloud application, the computer program product comprising:
one or more computer-readable tangible storage mediums and program instructions stored on at least one of the one or more tangible storage medium, the program instructions executable by a processor to cause the processor to perform a method comprising:
intercepting communications between an end device and the application using a service mesh;
analyzing frontend code of the application and external and internal network traffic of the application to produce a plurality of analyzed data;
identifying an application-agnostic gamification strategy based on one or more user interface (UI) elements in the application;
identifying an application-aware gamification strategy based on the plurality of analyzed data; and
dynamically injecting gamification elements from the identified gamification strategies into the frontend code of the application.

16. The computer program product of claim 15, the method further comprising:
initializing a gamification knowledgebase as a rule-set collection.

17. The computer program product of claim 15, the method further comprising:
verifying an impact of the injected gamification elements on the application.

18. The computer program product of claim 15, the method further comprising:
modifying one or more of the identified gamification strategies based on collected feedback.

19. The computer program product of claim 15, the method further comprising:
dynamically injecting one or more user-engagement features into the frontend code in addition to the gamification elements from the identified gamification strategies.

20. The computer program product of claim 15, wherein dynamically injecting the gamification elements from the identified gamification strategies into the frontend code is performed pursuant to one or more application user experience goals and one or more game control policies.
